(19) United States
(12) Patent Application Publication
(10) Pub. No.: US 2022/0144368 A1
(43) Pub. Date: May 12, 2022

(54) Low Polar Tandem bicycle

(71) Applicant: Robert Earl Means, JR., Sedalia, KY (US)

(72) Inventor: Robert Earl Means, JR., Sedalia, KY (US)

(21) Appl. No.: 16/974,182

(22) Filed: Nov. 6, 2020

(51) Int. Cl. B62K 3/14; B62J 1/08; B62J 25/08; B62M 9/00

(52) U.S. Cl. CPC B62K 3/14; B62M 9/00; B62J 25/08; B62J 1/08

(57) ABSTRACT

This Tandem bicycle design describes a reduced linear dimension, whereby the inherent polar integrity of the tandem structure is reduced.

Due to the close proximity of the cyclist, balance and coordination is more rapid and spontaneous.

The gear construct is comprised of a system of three cranking sprockets, closely arranged in a forward (one) and rearward pair. The forward and rear gears closest to the bicycle frame; coupled to a timing chain, functions as the timing mechanism. The rearward outer gear functions as the driving gear connected by a power chain to the rear wheel sprocket(s).

The handlebars required by the rear cyclist necessitates an innovative base connected to the bicycle frame located behind the front cyclist seat collar.

A locking mechanism on the handlebar coupler allows deployment of handlebars from retracted, to the riding position.

### BACKGROUND OF INVENTION

The bicycle was introduced in 1817.

This machine was a mode of self-driven locomotion, using a frame on which to sit, and a two pulley system to transfer power from the rider's legs to a rear wheel.

Eighty one years later, modification of the bicycle increased rider capacity to two, utilizing an expanded frame and a duplication of the previously engineered pulley system.

Conventional tandems are now defined by two or more seats incorporated onto a bicycle frame requiring two or more pulleys to transfer ‘pedal power’ to the rear wheel.

This current tandem design exploits the need for a design which increases the proximity of two cyclist on the bicycle frame, thus improving coordination and responsiveness.

The traditional leisure and racing tandem bicycle have been designed and constructed upon the same (or nearly the same) frame. Coordination between the forward and rear cyclist is again, nearly unchanged between said tandems.

The common factor in the majority of tandem design is the extended linear dimension of the frame between the suspension forks that attach to the front and rear wheels.

This extended linear dimension is in stark contrast to the design set forth in this application.

This current tandem design exploits the need for a design which increases the proximity of the two cyclist on the same bicycle frame, thus improving coordination and responsiveness.

### CROSS REFERENCE TO RELATED APPLICATIONS

These patents are referenced in that the claims pertain to tandem seating.

Specificity of these claims rest on invention characteristics unrelated to this patent application.

References cited:

| | | |
|---|---|---|
| 4029326 | January 1976 | Blow Jr. |
| 3943797 | March 1976 | Jollie |
| 3191965 | June 1965 | Wilkens |
| 3092362 | June 1963 | Walsh |
| 2715342 | August 1955 | Ridgway |
| 2361708 | October 1944 | Raba et al |
| 0133542 | February 1985 | EP |
| 2233696 | October 1999 | CA |
| 5503419 | April 1996 | Gardner |
| 5135246 | August 1992 | Montague |
| 4666172 | May 1987 | Hartmann |
| 4600206 | July 1986 | Di Paolo |
| 4502705 | March 1985 | Weaver |
| 474400 | May 1892 | McKenna |

### FIELD OF THE INVENTION

The present invention relates to tandem bicycles and specifically a racing tandem with a new configuration of reduced polarization between the forward and rear cyclist.

This Low Polar Racing Tandem Bicycle reduces mechanical response of cyclist to machine (ie. tandem cycle) as well as reducing mechanical gyroscopic positioning during road or track maneuvers.

### SUMMARY OF THE INVENTION

This tandem bicycle is a progressive evolution in cycling technology, promoting improved coordination and response timing between front and rear cyclist.

Using a contracted wheelbase and crank gear axes position, this tandem reduces the intrinsic polar construct of the bicycle frame, allowing the dual cyclist to function closer as one power entity.

Deploying the newly described rotating handlebars, a more proximal position of the cyclists is realized.

### BRIEF DESCRIPTION OF THE DIAGRAMS

The invention; described as the Low Polar Racing Tandem Bicycle, is structurally revealed in the graphics below.

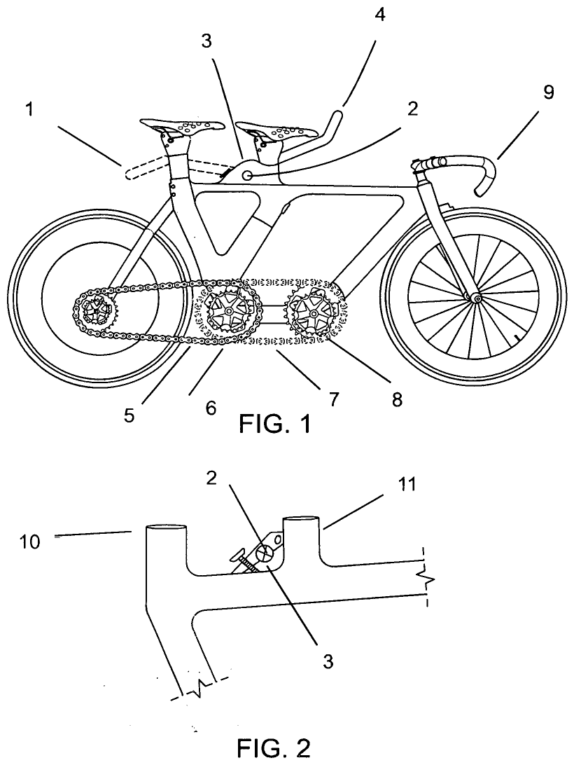

FIG. 1 Illustrates the aforementioned ‘contracted’ tandem bicycle frame with the handlebar connector as an integral component of the frame. The left handlebar is presented in the deployed and retracted positions. The right handlebar section is removed to aid in visualization of the handlebar connector.

FIG. 2 Illustrates an isolated close up view of the top bar of the tandem, the front and rear seat collars and handlebar connector in the closed position.

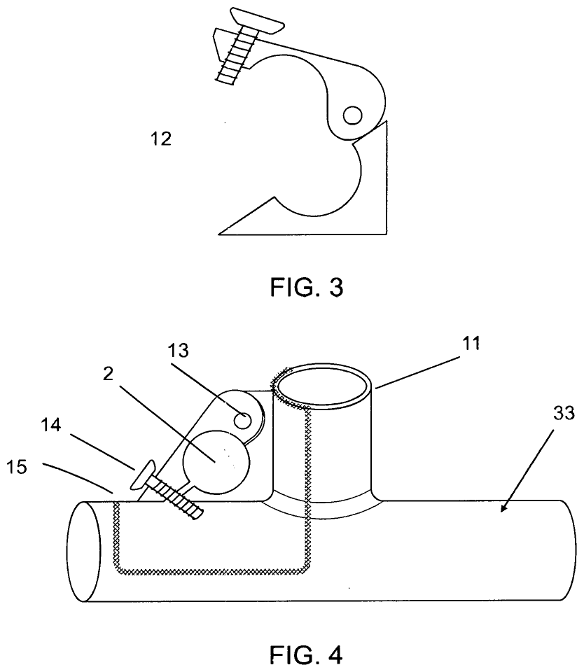

FIG. 3 Illustrates a close up view of the handlebar connector in the open position

FIG. 4 Illustrates a close up side view of the handlebar connector in the closed position.

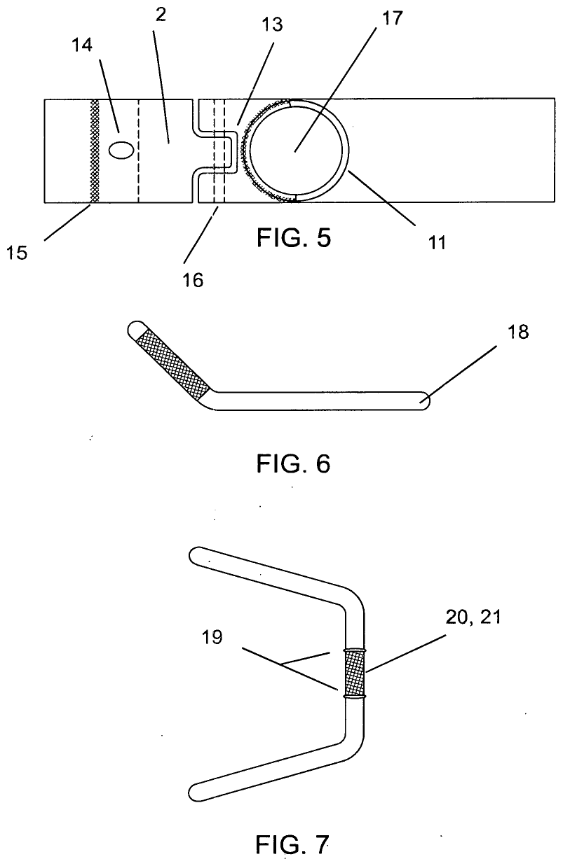

FIG. 5 Illustrates a close up top view of the handlebar connector in the closed position.

FIG. 6 Illustrates a side view of the single piece handlebars with knurled hand position.

FIG. 7 Illustrates a top view of the single piece handlebars.

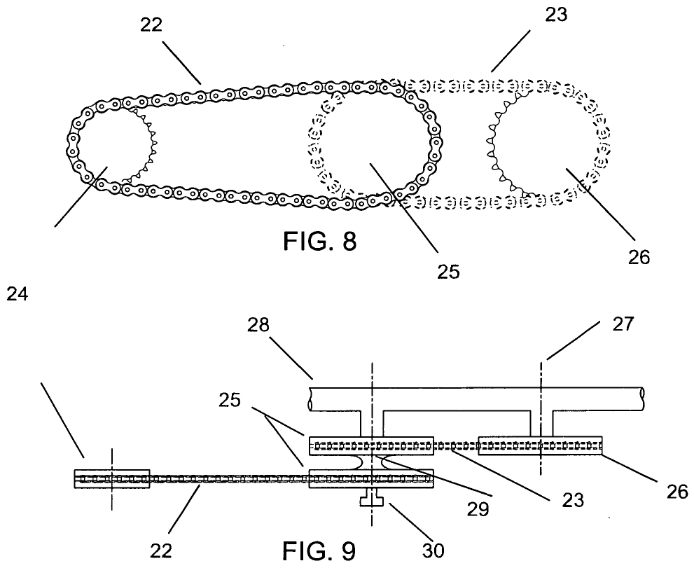

FIG. 8 Illustrates a side view of the gear system, involving front, rear and rear wheel sprockets. Associated drive and timing chains are engaged.

FIG. 9 Illustrates a top view of the spatial arrangement of the gear sprockets and corresponding drive and timing chains.

### DESCRIPTION OF THE INVENTION

This Low Polar Racing Tandem Bicycle design specifically addresses the unique configuration of a handlebar and frame connector, which when combined with an innovative contracted tandem frame, facilitates a center of gravity nearer to a single cyclist than the standard tandem bicycle frame. The closer proximity of the cyclists allows improved mechanical efficiency.

FIG. 1 references any typical bicycle frame, expanded to allow an additional seat directly behind the front cyclist seat. This double seating arrangement; depending on the size of the frame, would have a proximity measurement of approximately 51 cm. between any two identical parts of the seats. The corresponding foot pedal sprockets (6, 8) require a proximity of approximately 43 cm. The handlebar construct (1, 4) is a single hollow tube, configured to allow clearance from the front cyclist, while supporting the rear cyclist upper torso by the cyclist gripping with their hands and also having the capability to support the forearms via forearm rests.

In FIGS. 2, 3, 4 and 5, the handlebar connector (3) is referenced as an integral part of the tandem frame. By loosening the locking screw (14), the connector hinge (13) can be opened (12), allowing insertion or removal of the handlebar construct (1, 4). This mechanism also allows positioning of the handlebar construct into the deployed (4) or retracted (1) positions.

FIG. 6 illustrates the side view of the single piece handlebars (1, 4). There is a central point of rotation (18) built to engage the frame connector (3). The handlebar diameter will be of standard dimension for the industry. The hand grip will be knurled and angled at approximately 45 degrees for ergonomic comfort.

FIG. 7 illustrates the top view of the handlebar construct (1, 4). There is the central handlebar segment (21) that connects to the frame connector (3). The handlebar remains centered in the handlebar connector column (2) by use of centering collars (19) formed during handlebar manufacturing. In order to maintain handlebar stability during deployment (4), the central portion of the handlebar single piece is knurled to increase surface area tension between handlebars (1, 4) and frame connector (3).

FIG. 8 Illustrates the side view of the tandem gear system. This system encompasses four sprockets: the front sprocket (26), the middle double sprockets (25) and the rear wheel sprocket (24). The double rear frame sprockets (25) are conjoined by a sprocket connector (29), allowing cohesive synchronous rotation of the gears in the system when the bicycle chains are linked as shown in FIG. 9. The timing chain (23), connects the front single sprocket (26) to the more centrally positioned double rear frame sprocket (25). This chain configuration produces unwavering and dedicated positioning of the tandem pedals which cannot be altered. The front (26) and rear frame (25) sprockets are of equal dimensions. This allows the timing. chain (23) to function as a co-drive system. The rear frame outer sprocket (25) may accommodate other outer gears as seen in conventional bicycle designs for multi-gear capabilities. The drive chain (22) connects the double rear frame outer sprocket (25) to the rear wheel sprocket (24) to facilitate forward motion.

FIG. 9 illustrates the top view of the tandem gear system, encompassing the four sprockets (26, 25 and 24). The timing chain (23) is seen linking the equally dimensioned front frame sprocket (26) and the outer gear of the double rear frame sprocket (25). The drive chain (22) is seen linking the outer gear of the double rear frame sprockets (25) and the rear wheel sprocket (24).

The above description highlights the illustrations attached.

The claims define the intent of the invention.

### REFERENCE NUMBER IDENTIFICATION CHART

1 rear cyclist pivoting handlebar. retracted. right bar removed
2 column for handlebar segment B.
3 frame connector A. closed
4 rear cyclist pivoting handlebar. deployed. right bar removed
5 drive chain connected to the outside rear sprocket
6 double rear frame sprockets
7 timing chain
8 single front frame sprocket
9 front cyclist handlebars
10 Rear seat post collar
11 Front seat post collar
12 Frame connector for handlebars A. open
13 Hinge
14 Locking screw
15 Welding (connection) to top bar
16 Hinge axis
17 Column for front seat post
18 Point of rotation to engage handlebars to position change
19 Centering collars
20 Knurled surface of central handlebars
21 Handlebar segment B. to connect to frame connector A.
22 Drive chain
23 Timing chain
24 Rear wheel sprocket
25 Double rear frame sprockets
26 Single front frame sprocket
27 Axis of rotation of front sprocket
28 Bicycle frame
29 Double rear frame sprocket connector
30 Pedal base
31 Axis rotation double rear frame sprocket
32 Axis rotation rear wheel sprocket
33 Bicycle frame top bar

The invention claimed is:

1. An innovative Tandem Racing Frame attached to standard bicycle wheel axes.

2. The uniqueness of the tandem frame is referenced to the connective structure of the frame aft of the front seat. The frame supports tandem seats, supported by front and rear diagonal columns attaching to the top horizontal bar as seen on a standard bicycle. The seat heights; as in conventional bicycles, are adjustable.

3. The rear seat column incorporates a sprocket drive system as seen in conventional bicycles. The distance between the tandem sprocket axes measure approximately 43 cm depending on the requested specifications of the cyclist.

4. The uniqueness of the tandem handlebars is referenced to the pivoting locking hinge; connected to the rear of the front seat collar, allowing repositioning of the uni-constructed handlebar arms. The handlebars rest in the backwards position when not in use, and allows a forward position beyond the front seat position when the rear cyclist is in play. The central hinge incorporates corrugated surfaces to facilitate stability when the handlebars are positioned. A locking screw is enlisted to open and close the top of the connector which is located behind the front seat collar.

5. The drive chain of the Racing Tandem allows the forward cyclist to contribute to the torsional drive force through a single forward sprocket which connect to the (inner-midline) rear sprocket via a timing chain. The ratio of the forward and rear sprockets are 1:1. The rearward (inner-midline) sprocket is connected to the rearward outer sprocket. Depending on cyclist specifications, the gear ratio starts at 1:1, and may vary with multiple gears located to the right of the aforementioned rear sprocket. While the tandem is in transit, the gears are regulated by the forward cyclist as in conventional tandems.
